(19) United States
(12) Patent Application Publication
(10) Pub. No.: US 2025/0086286 A1
(43) Pub. Date: Mar. 13, 2025

(54) SOFTWARE SECURITY MANAGEMENT

(71) Applicant: Wells Fargo Bank, N.A., San Francisco, CA (US)

(72) Inventor: Jerry Joseph Reynolds, Charlotte, NC (US)

(21) Appl. No.: 18/462,817

(22) Filed: Sep. 7, 2023

(51) Int. Cl. G06F 21/57; G06F 21/55

(52) U.S. Cl. CPC G06F 21/577; G06F 21/552; G06F 21/554

(57) ABSTRACT

Systems and methods may generally be used for security debt management. An example method may include identifying a security risk assessment including at least one security defect of an application, a set of applications, an enterprise, etc. The method may include determining, for example using a model, a security debt score for the application based on the security risk assessment. The method may include comparing the security debt score to a security debt threshold for the application, and determining, for a particular time period, a minimum remediation for the at least one security defect of the application to reduce the security debt score. In some examples, the minimum remediation is based on a minimum remediation due during the particular time period and the security debt score.

### BACKGROUND

The application of information and cyber security expertise is currently a manually intensive practice. Prescribing accurate and contextual security prevention and remediation guidance, as well as measuring or assigning risk to systems, requires human processing and understanding of several factors. These factors may include a make-up of a system, software language and frameworks used, dependent components, services, or systems, deployment and hosting environments and locations, user or subject types and locations, data types and formats, features and functions of the system, compensating controls, functional and non-functional requirements, or the like. In an agile environment where the pace of change is fast and increasing, especially in large organizations, the availability and scalability of experts to ensure the balanced application of security and resiliency is increasingly intractable.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a dashboard for showing security debt in accordance with some embodiments.

FIG. 2 illustrates a block diagram showing an application management framework in accordance with some embodiments.

FIG. 3 illustrates a security debt remediation block diagram in accordance with some embodiments.

FIG. 4 illustrates a machine learning engine for training and execution related to determining a debt score from an assessment for an application in accordance with some embodiments.

FIG. 5 illustrates a flowchart showing a technique for security debt management in accordance with some embodiments.

FIG. 6 illustrates a flowchart showing a technique for security credit management in accordance with some embodiments.

FIG. 7 illustrates generally an example of a block diagram of a machine upon which any one or more of the techniques discussed herein may perform in accordance with some embodiments.

### DETAILED DESCRIPTION

The pace of change of information and cyber security has accelerated with an increasing volume of assets for example due to legacy software being broken down into constituent smaller parts, such as microservices. Other challenges include a constantly changing threat landscape, and an increasing stress on a limited pool experts. To address these issues, tools and processes have been created and adopted. Some tools use rules or signature-based engines with accuracy limited to the quality of inputs and rules. Other tools use signatures that are point-in-time and relatively slow to change. The outputs may lack granularity, preciseness, or applicability, leading to high false-positive results or a disassociation of risk from specific business or technical concerns. These results often require manual intervention by experts, or include false-negatives, which introduce risk into a system. Moreover, these tools and processes tend to be created in parallel to non-security tools and processes, and are often separately managed by information and cyber security experts, which compounds the problem of expert scalability.

The result of these issues tends to be a philosophical or practical separation between the treatment and application of security defects and requirements on the one hand, and business and technical defects and requirements on the other. This may be observed, for example, when one set of tools, processes, and people are used to define business and technical work through software requirements or user stories, and another set is used to identify and manage corresponding security work, generally without associating the security work with the impacted business and technical work. A security governance process is typically used to track and remediate unmet security requirements and security defects, for example managed by information and cyber security groups, which compounds the problems of expert scalability and disassociation of security risk from business and technical concerns.

These parallel processes and tool chains tend to allow businesses to deploy business and technical changes with security defects or unmet security acceptance criteria, for example managed in separate processes that apply remediation criteria to all unmet security requirements and security defects. In an example, critical defects may block deployments, but lower risk defects (e.g., low or medium risk defects) may be allowed to be deployed, but must be remediated or fixed within a time period, such as 30 days, 90 days, a year, etc. for each defect instance (e.g., for each software or application product). By applying such strict requirements on remediation criteria, large organizations with many software or application products become paralyzed as they try to adhere to a granular per-defect or per-application process. Risk management is effectively removed from business, and prescribed and enforced by cyber security or governance groups. This model punishes everybody, even teams that otherwise succeed by introducing very few, low risk defects or delay low risk security requirements.

The systems and techniques described herein provide a technological framework to facilitate improved security for an application, a set of applications, over an enterprise, or the like. These systems and techniques integrate security into business decision process flows, while providing remediation options and tracking adherence over time. A model may use security considerations as an input, to provide remediation requirements or suggestions to a user. In some examples, remediation may be automated, for example depending on aspects of the debt and applicable controls that may be triggered based on policy definition or triggers. For example, automatically created work tickets may be added to the a backlog for remediation or implementation. In some examples, one or more options may be provided automatically, one or more of which may be selected by a user, for example on a user interface.

The systems and techniques described herein solve the technological problem of maintaining security of an application, set of applications, enterprise, etc., which include the subjective and incomplete issues described above. The technological problem is a structural one that is tied to the inherent tradeoffs between security risk and deployment of an application.

One example technical advantage provided by the technical solutions set forth herein includes solving and communicating security concerns without disrupting application roll out. The present systems and techniques integrate security risk remediation into typically non-security processes to address security risks in a manner that is quicker, more agile, and more precise to the application in question than legacy techniques. A model (e.g., a machine learning trained model) may be used to determine a security debt score for an application based on a security risk assessment. A recommendation or requirement (e.g., a minimum remediation) may be generated based on the security debt score, defect density in a specific asset (e.g., an application or a microservice that belong to a product's bucket of assets).

The systems and techniques described herein include a security debt identification, scoring, measurement, or management process that applies a financial debt ontology or model (e.g., using domain driven design) to manage risks posed by unmet security requirements and security defects, such as vulnerabilities, threats, privacy gaps, or regulatory requirements. The model may apply scoring criteria to an amount, a type, a severity, or an age of unmet security requirements and security defects. Interest may be accrued on existing debt, or impact an overall debt score. In some examples, interest on new security debt may be applied, a minimum remediation (e.g., a minimum reduction of carried debt over a time period) may be required or recommended, or penalties for missed payments (e.g., reduction of security debt) may be used.

A security credit score for an organization, an application, a set of applications, or the like may be increased by consistently paying down debt, or limiting the accrual of new debt. The use of technological controls may be used to reduce interest on security defects or unmet security requirements (e.g., vulnerabilities, threats, privacy gaps, regulatory requirements, or the like) in a similar way the loans permit the up-front pay-down of interest rates. For example, when a web-based application is carrying a number of defects and unmet security requirements, but is deployed with a properly configured Web Application Firewall in blocking mode to help prevent specific attacks, the security defects and unmet security requirements that are covered by the WAF may carry a lower interest, which reduces overall compounding debt, and increases a security credit score, a security debt limit, a security health score, etc. By allowing common, testable controls to contribute to security debt reduction, the process balances the two common extremes of defect remediation and meeting security requirements.

The security debt score with consideration of controls (e.g., a limited approved number of controls, such as external controls including web app firewall, intrusion detection systems, intrusion prevention systems, runtime application self-protection, or the like, which may be automatically validated) allows the systems and techniques described herein to avoid two extremes of allowing businesses to negotiate the application of compensating controls on every defect or unmet security requirement and not considering compensating controls at all, which may artificially increase the risk or severity of defects or unmet security requirements (e.g., including vulnerabilities, threats, regulatory requirements, privacy gaps, etc.). For example, some current security defect priority mechanisms include time-to-fix requirements that mandate how long a defect may exist before becoming a blocker for software deployments. This inadvertently forces businesses to decide to fix old low risk defects to avoid negative compliance consequences instead of fixing a high-risk defect and deploying a more critical defect into production with a plan to fix within its time-to-fix criteria.

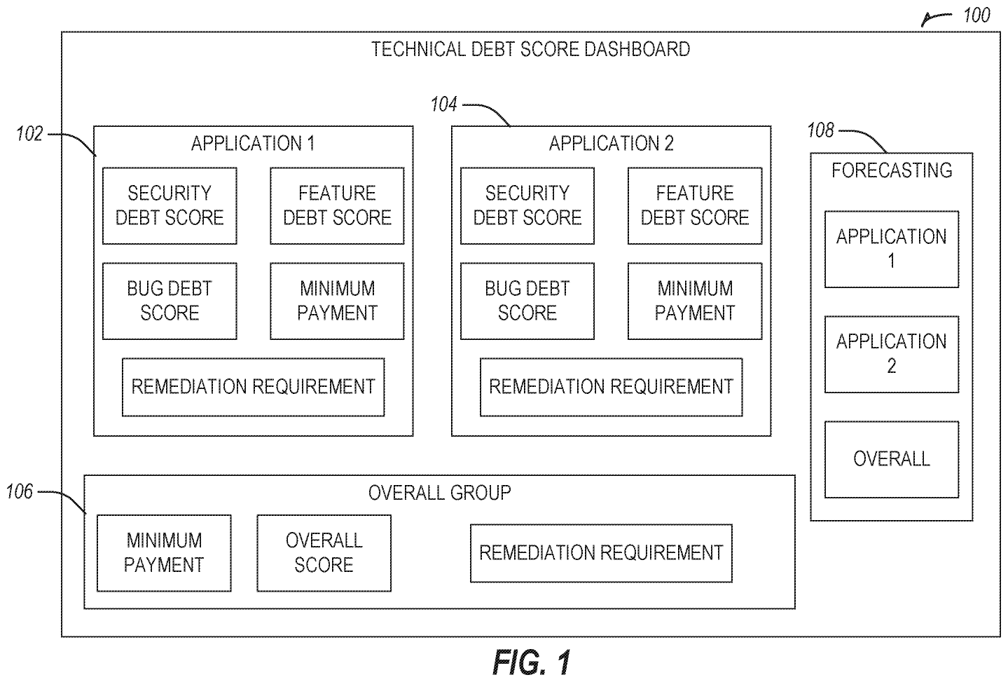

FIG. 1 illustrates a dashboard 100 for showing security debt in accordance with some embodiments. The dashboard 100 shows an example configuration, but more or fewer of the illustrated components may be displayed on the dashboard 100 in some examples. In the illustrated example, the dashboard 100 includes a first application component 102, a second application component 104, and an overall group component 106. In other examples, only a single application component or only an overall group component may be shown. In still other examples, more than two application components may be shown or summarized (e.g., for an enterprise).

The dashboard 100 shows the first application component 102 including a security debt score, and optional other debt scores, such as a feature debt score or a bug debt score. The debt scores shown for the first application component 102 may be combined and shown as a total technical debt score, in some examples. The security debt score may be generated using a model (e.g., a trained machine learning model) based on a security risk assessment for a first application corresponding to the first application component 102. The security risk assessment may consider various aspects of security for the first application, such as number of security issues, level of security issues, compensating controls, risk of security issues, degree of difficulty in fixing security issues, specified time to fix security issues, or the like.

The first application component 102 may include a minimum payment (e.g., a minimum remediation) due to address security or other debt, such as for a particular time period (e.g., a day, a week, a month, a quarter, a year, etc.). The minimum payment may be based on the security debt score, or may include a default minimum. A remediation corresponding to the minimum payment may be displayed in the first application component 102, or may be displayed (e.g., with further details), when the minimum payment is selected (e.g., on a user interface). The first application component 102 may include a remediation requirement. The remediation requirement may include (e.g., when selected, display) a total set of security debts to address. In some examples, the minimum payment may include a debt score to achieve (e.g., lower the security debt score to a particular score, such as one below a threshold). The remediation requirement may display a selected set of remediation (e.g., pay off all debt, pay off the minimum payment, pay off some level in between, or the like).

The first application component 102 may include an interest due (e.g., on the total security debt score, on the security debt score after the minimum or other payment is made, etc.). The interest due may include an increase to a default remediation, an increase to the security debt score, etc.

The minimum payment, minimum remediation, remediation requirement, or interest may correspond to only one of the security debt score, the feature debt score, or the bug debt score, or may be related to a combination of two or more of these debt scores (or other debt scores). The first application component 102 may be changed to illustrate information corresponding to a debt score or combination of debt scores, such as based on a user selection, a user role (e.g., engineer, technical lead, project manager, director, manager, chief technical officer, chief security officer, or the like), an application type, etc.

The dashboard 100 may illustrate a second application component 104, which may include information corresponding to a second application, such as a security debt score, feature debt score, bug debt score, minimum payment, remediation requirement, interest, etc. The first application component 102 and the second application component 104 may correspond to related applications, may share a common microservice, may both be assigned to a particular user of the dashboard 100, or the like.

The dashboard 100 may include an overall group component 106. The overall group component 106 may be used to display aspects of technical debt related to two or more applications (e.g., a set of applications for a user, group, or enterprise), asset types, (e.g., software assets, hardware or infrastructure assets, databases, networking equipment, ATMs, security systems (cameras, biometrics, etc.), etc.), personnel, or the like. The overall group component 106 shown in FIG. 1 includes a minimum payment (e.g., a minimum remediation), an overall score, and a remediation requirement. In other examples, the overall group component 106 may include fewer, more, or other components. The overall score of the overall group component 106 may correspond to a security debt score of two or more applications (e.g., for an overall group, which may correspond to a user, a team, a company, etc.). In some examples, the overall score may include a feature debt score, a bug debt score, another debt score, or a combination of two or more debt scores, such as a total technical debt score. The minimum payment or remediation requirement for the overall group component 106 may correspond to all applications or a set of applications for the overall group (e.g., for the user, team, company, product, customer journey, etc.). For example, a minimum remediation may be displayed that includes closing a particular security risk for all applications in a group. In other examples, the minimum remediation may correspond to lowering the overall score, in whatever manner the user chooses.

The dashboard 100 provides clarity in the security debt score, making the score easy to access, read, and understand, as well as making it easier to implement changes to the application by providing the visual feedback. The minimum payment or remediation requirement provides flexibility for lowering a debt score, giving more autonomy to a user. For example, a chief information officer may choose to lower an organization's debt by addressing all defects in the applications that hold 80% of total security debt, or may create a special remediation team to create a solution that resolves all instances of a specific defect in all applications.

The security debt score may be based on a security risk assessment, which is input into a model. The model may be trained according to security or governance organization parameters, a scoring mechanism, a penalty, an interest, or the like. The security debt score (or other debt score) may be customized for the application, for an enterprise, for a team, for a user, for a product, for a customer journey, etc.

In some examples, the dashboard 100 may display a forecast 108, such as a forecast 108 of a debt score (e.g., security, feature, bug, technical, etc.) based on a current debt score and an available remediation. The forecast 108 may use various inputs to identify a future debt score, such as typical remediation by a user or team, possible remediation within a time period, interest (e.g., a weight that may be based on risk or time a security debt remains unpaid), etc. The forecast 108 may provide a warning in some examples, such as when a forecasted debt score exceeds a threshold. The warning may indicate a minimum remediation to keep the forecasted debt score below the threshold, which in some examples may exceed a minimum remediation for a current time period. The forecast 108 may include forecasted future debt (e.g., debt that is likely to be incurred, such as based on a new application or feature launch). The forecast 108 may be specific to an application, enterprise, team, user, product, customer journey, etc. In some examples, the forecast 108 may be an overall forecast. The forecast 108 may provide a future debt score, a future risk of a debt score falling below a threshold, a likelihood of one or more debt scores or range of debt scores, or the like. The forecast 108 may include one or more planned security debt payments (e.g., a remediation) or estimated introduction of new security debt based on previous habits (e.g., historical addition of security debt), product complexity, product, asset, or team health scores, or the like.

A remediation may include addressing a risk factor, such as by rewriting code, removing or redoing a feature, closing a communication path, implementing a control, or the like. In some examples, a control may include a web application firewall (WAF), a run-time application self-protection, or the like. When considering capital controls, the security debt score may be generated after automatically validating that the rules of a control are qualified to a baseline and that the control contains the risk.

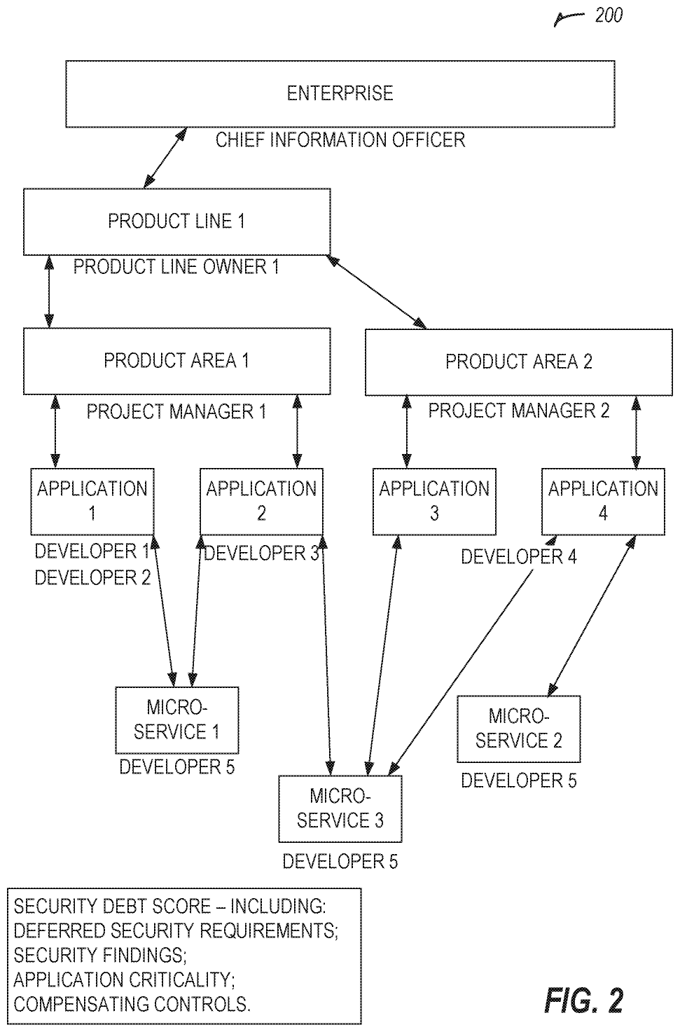

FIG. 2 illustrates a block diagram 200 showing an application management framework in accordance with some embodiments. The block diagram 200 shows how an application may be assigned to various users, groups, organizations, or the like, and where each application may fit into an overall hierarchy. The block diagram 200 may be used to assign a security debt score to a user, for example to provide on a user interface. In an example, when an application appears in a user's hierarchy, information corresponding to the application (e.g., a debt score) may be displayed by default or automatically in a user interface for the user (e.g., the dashboard 100 of FIG. 1).

The block diagram 200 may be used to show who is in charge of a debt load (e.g., for a particular application or group). The debt load may correspond to a portfolio, a line of business, a product strategy, a product line, or the like. The debt load may be managed at one or more of these levels, such as by an application owner, a product owner, etc. A debt score or remediation for a user may differ according to the user's level (e.g., number of applications, how directly the user controls an application, team members who also contribute to managing the application, or the like). For example, a developer working on a single application may be responsible for a security or other debt score corresponding only to the single application. The developer's manager may be managing three separate applications, and thus the manager may have a debt score corresponding to the three separate applications (e.g., a combined debt score). The manager's supervisor may be responsible for a line of business, including dozens of applications. The supervisor may have a debt score corresponding to the entire line of business, in some examples. Each of these different levels, debt scores, or remediations may have a corresponding threshold. For example, a developer may be responsible for keeping an application debt score under a threshold for the single application, while the manager may be responsible for keeping a three-application debt score under a second threshold for the three applications, etc. Actions taken by the developer may affect the manager's debt score, and vice versa, in some examples. For example, the developer may lower an application debt score, causing a three-application debt score of the manager to decrease. However, the three-application debt score may still be above a threshold, and the manager may use additional remediation (e.g., for one of the other two applications). This may result in cases where a user may take remediation action even when the user's debt score is below the user's threshold (e.g., the developer may need to take a remediation action to lower the debt score further to get the three-application debt score below the manager's threshold).

Remediation actions may be taken or suggested (e.g., output from an automated process based on a threshold, debt score, minimum remediation, or the like). Remediation actions may encourage users to focus on high debts on applications to quickly lower the debt score. This may result in debts being addressed not in the order they were identified or received, but in an order that minimizes the security debt score. By incentivizing and focusing on minimizing the security debt score (assuming that the score has been properly configured), an optimal or improved process of addressing security issues may be used.

Over time, information related to security (or other) debt scores, thresholds, interest, minimum payments, required remediations, or the like may be captured. The captured information may be used to perform analytics to determine what security risks are contributing most to security debt scores, which developers or combination of developers are introducing risk, which applications are introducing risk, which languages (e.g., coding language, framework, technology, etc.) are introducing risk, or the like.

Analytics of past data may include determining criteria that raises a debt score of an application, such as having clean code, documentation, hosted on approved cloud host, good design patterns, removing negative impacts (e.g., patching software, reducing security vulnerabilities, or the like), etc. For example, a number of best practices for an application score may be determined, and an evaluation may include determining how many of those are being done effectively for a particular application. The performance on these best practices may be measured, and compared with other applications to determine whether one or more of the best practices impacts the security debt score. In some examples, an improved path for how to add a feature to minimize bug or security debt may be determined. Other examples of use for analytics include determining whether security debt is being inherited from a particular host, deployment, or framework.

A security debt score may be a measure of security related technical debt (where a lower score is preferable) or a security credit type of score (where a higher score is preferable). A measurable security debt may apply to assets (e.g., products, applications, etc.) people, organizations, etc. A security credit score may be applied to an individual, a role, an organization, etc. The security credit score may be temporary, in some examples. For example, an individual may take on new security debt and establish a new score as roles or responsibilities change for that individual within an organization (e.g., promotions, lateral moves to new teams).

In some examples, a security debt score may include a combination of individual or asset combinations. For example, a developer or development team may work on multiple software products or applications. A developer in this example may have more than one security debt score, such as for each specific software asset, application, product, or the like that the developer works on or is responsible for.

In FIG. 2, arrows may imply that addressing a debt score of one component may affect another. The chain of components reflects flow of debt score impact. For example, the enterprise level may be affected by all lower components, while the micro-services may only be affected by themselves (although in some examples, a higher level component may affect a lower level component, such as when an application uses a micro-service in an insecure manner, and closes the security risk). FIG. 2 illustrates examples of users who may be responsible for debt scores at each level, for example at the enterprise level, a chief information officer, at the product line level, a product line owner, at the product area level, a project manager, etc. Some components may have more than one user responsible (e.g., a team of developers, such as for application 1). In other examples, a user may be responsible for more than one application or component at a particular level (e.g., developer 4 for applications 3 and 4 or developer 5 for the three micro-services).

In an example, a debt score for a component of the block diagram 200 may include a security debt score. The security debt score may be based on deferred security requirements, security findings, application criticality, compensating controls, or the like. Scores for levels other than the application level may be aggregated (e.g., for product areas, product line, enterprise) or partitioned (e.g., for micro-services).

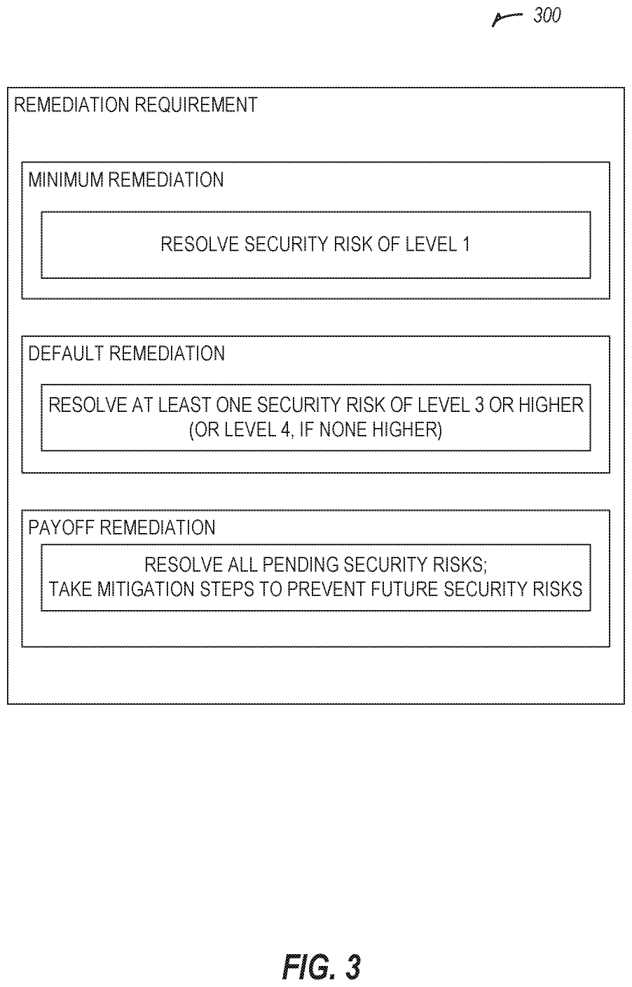

FIG. 3 illustrates a security debt remediation block diagram 300 in accordance with some embodiments. The security debt remediation block diagram 300 includes example remediations that may be applied to lower a debt score (e.g., a security debt score, a bug debt score, a feature debt score, a total technical debt score, or the like). A security remediation may be applied to address a security risk, a bug remediation may be applied to fix a bug in an application (e.g., identified pre-production by a developer or in production by a user), or a feature remediation may be applied to address a missing feature (e.g., a feature that was not implemented when an application was deployed, or a feature that has been requested since deployment). A debt score may be affected by a remediation required for a different debt score. For example, fixing a security risk may eliminate a bug, or implementing a feature may introduce a new bug or security risk.

The security debt remediation block diagram 300 includes example remediation requirements, such as a minimum remediation, a default remediation, or a payoff remediation. Other remediations may be shown in the security debt remediation block diagram 300 in some examples. The minimum remediation, for example, may include resolving a security risk of level 1, when present for an application. The minimum remediation may be based on a security debt score exceeding a threshold. The default remediation may be required even when the security debt score is below the threshold, and may include resolving at least one security risk of level 3 or higher, unless none exist, and then a level 4 security risk. A payoff remediation may be provided to show what paying down the entire or substantially all of the security debt score includes, although in some examples this remediation may be unachievable due to time constraints. The payoff remediation may include resolving all pending security risks (or all risks above a particular level), or taking mitigation steps to prevent future security risks. In some examples, the remediation requirement may identify a deployment remediation, which may be necessary to address before an application is allowed to deploy.

Security risks may be identified according to known issues, such as via regulatory requirements, Payment Card Industry Data Security standards, industry standards, GLBA, GDPR, etc. In some examples, risks may be identified via an attack, an identified vulnerability, a loss of customer, or the like.

In some examples, there may be tension between security health or worthiness and one or more types of debt, such as security, bug, or feature debt scores. For example, a limited amount of time or resources may be available to address these debt scores, or one of these debt scores may be given a higher priority or attention in some examples.

When a remediation is performed, an interest may be lowered or a debt score may be lowered. When a debt balance is carried forward or a minimum remediation is not performed, an interest or penalty may be accrued. Each security risk may have a corresponding severity (e.g., on a numbered scale, such as one to four). For higher severity (e.g., a score of one), then the application is prevented from being deployed. For lower severities, longer time frames may be given to fix. If the time frame is exceeded, the severity may be increased, or interest may accrue, impacting a debt or security score, which in some cases may result in an indication to undeploy or immediately fix a security risk of an already deployed application. The longer the security risk or issue remains unaddressed, the more it contributes to debt (e.g., minimum payments may not be sufficient to pay for increased debt due to added interest). This may lower a security credit worthiness score, increases the carried debt, or reduces the available credit (e.g., a difference between the carried debt and the credit balance). In some examples, an enterprise may have a technical hard-gate blocker to prevent deployment in some circumstances. In some examples, instead of considering individual severity scores, a security debt score may be used. Using the security debt score provides additional security for consideration of cases where many security risks exist, which cumulatively may represent severe risk. Failure to implement a remediation (e.g., a minimum remediation) may result in an internal financial penalty (e.g., a loss of bonus eligibility, a reduction in budget, defunding of a project, reprioritization of a planned project, etc.).

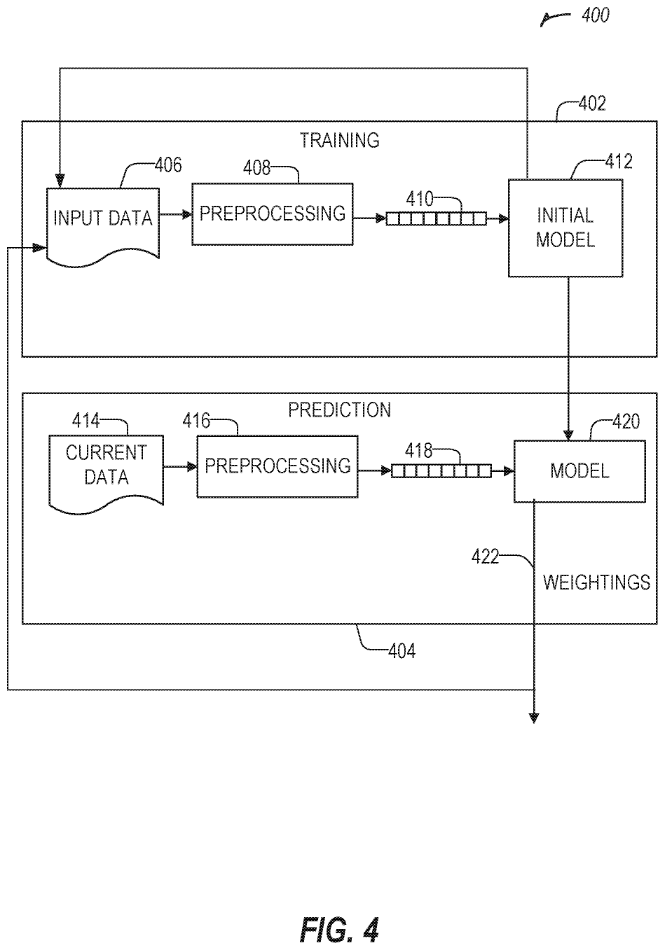

FIG. 4 illustrates a machine learning engine for training and execution related to determining a debt score (e.g., a bug debt score, a feature debt score, a security debt score, etc.) from an assessment (e.g., a bug assessment, a feature assessment, a security risk assessment, etc.) for an application in accordance with some embodiments. The machine learning engine may be deployed to execute at a mobile device (e.g., a cell phone) or a computer. A system may calculate one or more weightings for criteria based upon one or more machine learning algorithms. FIG. 4 shows an example machine learning engine 400 according to some examples of the present disclosure.

Machine learning engine 400 utilizes a training engine 402 and a prediction engine 404. Training engine 402 uses input data 406, after undergoing preprocessing component 408, to determine one or more features 410. The one or more features 410 may be used to generate an initial model 412, which may be updated iteratively or with future unlabeled data.

The input data 406 may include assessment data, which may vary depending on which debt score or combination of debt scores is modeled by the machine learning engine 400. For example, for a bug debt score, input data may include a number of bugs, a rate of new bug identification, an average or median time to fix bugs, a level of importance of bugs, etc. For a feature debt score, parameters related to uncompleted features may be provided, and may include labels of importance or impact of features. Security debt scores may have input data 406 such as level of security risks, number of security risks, time to fix timeframes, etc. The input data 406 may be generated from a source, such as one or more of standards, submitted information (e.g., bug report, feature punch list, security flaw identification, etc.), or the like.

In the prediction engine 404, current data 414 may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on an implant device, etc.). In other examples, the training engine 402 may operate in an online manner (e.g., at a mobile device). In some examples, the model 420 may be periodically updated via additional training (e.g., via updated input data 406 or based on labeled or unlabeled data output in the weightings 422) or feedback (e.g., based on observed security vulnerability or strength with corresponding security debt scores, common best practices compared to security debt scores, etc.). The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418.

Once trained, the model 420 may output a debt score, such as a security debt score, a bug debt score, a feature debt score, a technical debt score, or the like. In some examples, the model 420 may predict future debt scores, such as based on likely or minimum remediation of a current debt score.

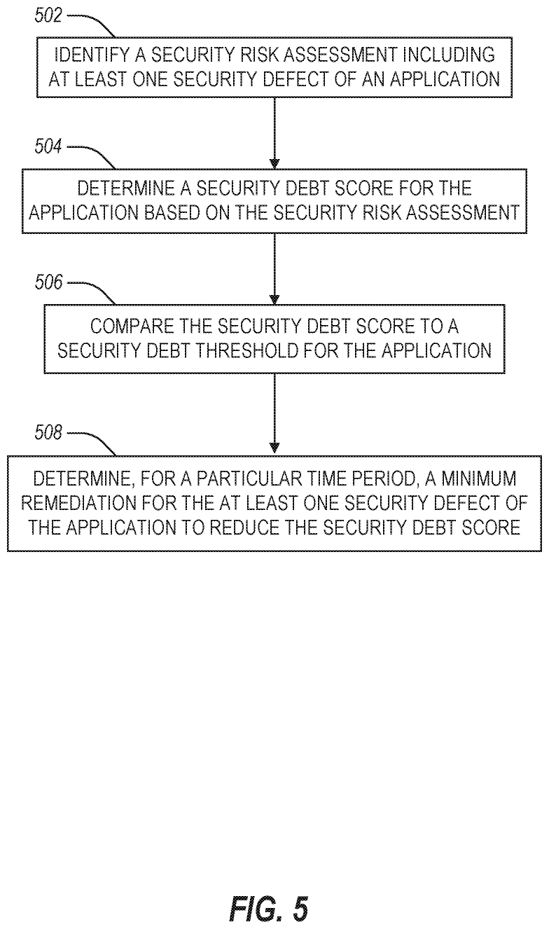

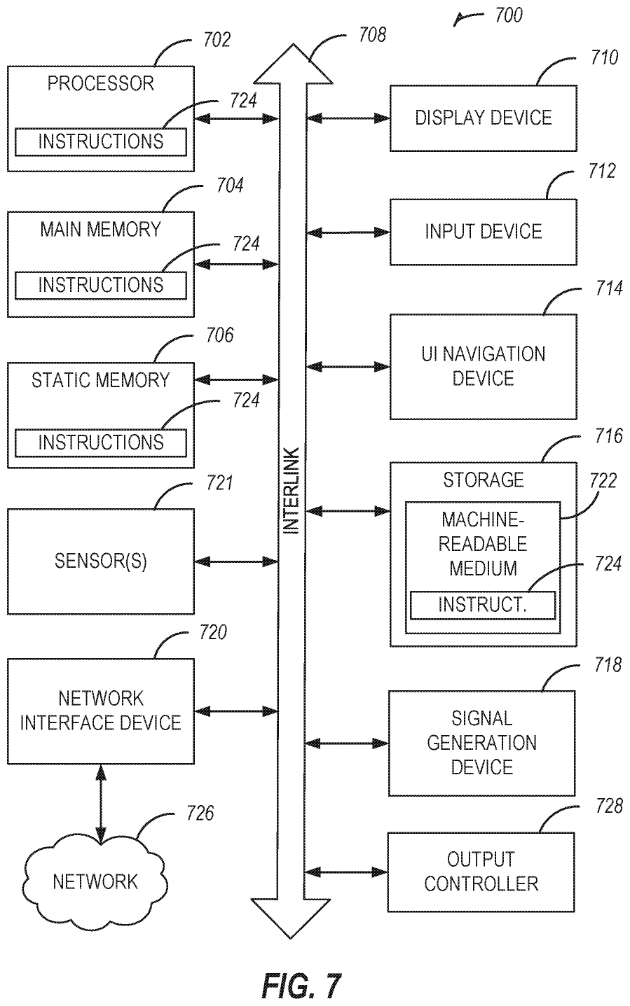

FIG. 5 illustrates a flowchart showing a technique 500 for security debt management in accordance with some embodiments. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 7.

The technique 500 includes an operation 502 to identify a security risk assessment including at least one security defect of an application. The security risk assessment may include metadata corresponding to the at least one security defect. The metadata may include at least one of type, severity, age of the at least one security defect, or the like. In some examples, the security risk assessment corresponds to a set of applications. In these examples, the minimum remediation may apply to at least one of the set of applications or all of the set of applications. In other examples, the security risk assessment corresponds to an enterprise. In these examples, the minimum remediation may apply to a common security defect among a plurality of applications of the enterprise. The security risk assessment may include at least one compensating control for the application. In an example, the security risk assessment is based on an amount, a type, a severity, an age of an unmet security requirement of the application (e.g., a password strength requirement), or the like.

The technique 500 includes an operation 504 to determine, using a model, a security debt score for the application based on the security risk assessment. The model may include a machine learning model, for example as discussed above with respect to FIG. 4. The technique 500 includes an operation 506 to compare the security debt score to a security debt threshold for the application.

The technique 500 includes an operation 508 to determine, for a particular time period, a minimum remediation for the at least one security defect of the application to reduce the security debt score. The minimum remediation may be based on a minimum remediation due during the particular time period and the security debt score. The minimum remediation may be determined based on the security debt score traversing the security debt threshold. When the security debt score traverses the security debt threshold, the minimum remediation may include a remediation to lower the security debt score below the security debt threshold. In other examples, the minimum remediation may be based on a default minimum remediation for the particular time period, for example, when the security debt score does not traverse the security debt threshold. The default minimum remediation may be required for all time periods or each set of time periods, regardless of the overall security debt score. The minimum remediation may be increased at an end of a subsequent time period when the minimum remediation is not addressed during the subsequent time period. In an example, the minimum remediation is based on a total technical debt score. The total debt score may include the security debt score and at least one other technical debt score based on a bug or a missing feature of the application. In some examples, interest is accrued on the security debt score. In an example, the minimum remediation may be increased for a subsequent time period based on the interest.

The technique 500 may include an operation to display aspects of the technique 500, such as the security debt score, a carried debt balance, the minimum remediation, an interest accrued if the carried debt balance is not paid, an interest accrued if only the minimum remediation is paid, a penalty due if the minimum remediation is not addressed, or the like. The technique 500 may include determining before a subsequent time period, a future minimum remediation, for the subsequent time period, for the at least one security defect of the application to prevent a penalty based on the security debt score. The technique 500 may include identifying a largest cause of the security debt score including at least one of a programming language, a host, a deployment, or a framework of the application, and displaying the largest cause. The largest cause may be displayed in some examples. In an example, an application, code, or a system complexity may impact a security debt score or a security credit score. In some examples, the complexity may be an attribute of a prediction model where more complexity increases the likelihood of risk or more difficulty in reducing the debt (e.g., remediation).

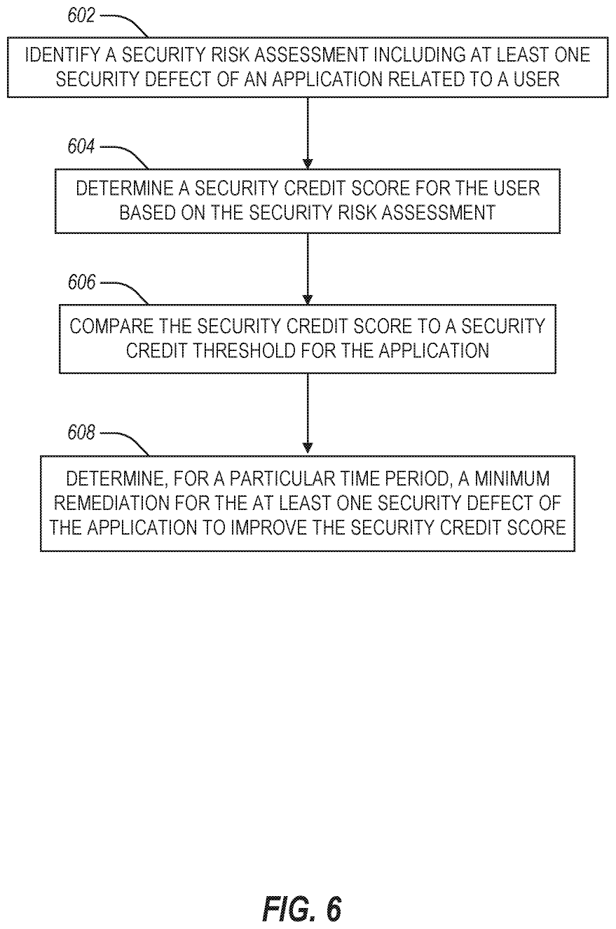

FIG. 6 illustrates a flowchart showing a technique 600 for security credit management in accordance with some embodiments. In an example, operations of the technique 600 may be performed by processing circuitry, for example by executing instructions stored in memory. The processing circuitry may include a processor, a system on a chip, or other circuitry (e.g., wiring). For example, technique 600 may be performed by processing circuitry of a device (or one or more hardware or software components thereof), such as those illustrated and described with reference to FIG. 7.

The technique 600 includes an operation 602 to identify a security risk assessment including at least one security defect of an application related to a user. The security risk assessment may include metadata corresponding to the at least one security defect, the metadata including at least one of type, severity, or age of the at least one security defect. The security risk assessment may include at least one compensating control for the application.

The technique 600 includes an operation 604 to determine a security credit score for the user based on the security risk assessment. Operation 604 may include using a model to determine the security credit score for the user. The security credit score for the user may be determined based on a set of applications and corresponding security debts for the set of applications. Operation 604 may include determining the security credit score based on an amount, a type, a severity, or an age of an unmet security requirement of the application.

The technique 600 includes an operation 606 to compare the security credit score to a security credit threshold for the application.

The technique 600 includes an operation 608 to determine, for a particular time period, a minimum remediation for the at least one security defect of the application to improve the security credit score. The minimum remediation may be based on a minimum remediation due during th particular time period and the security credit score. In an example, the minimum remediation is determined based on the security credit score traversing the security credit threshold. In an example, the minimum remediation is increased at an end of a subsequent time period when the minimum remediation is not addressed during the subsequent time period. The technique 600 may include determining, for a subsequent time period, a future minimum remediation, before the subsequent time period, for the at least one security defect of the application to prevent a penalty based on the security credit score.

FIG. 7 illustrates generally an example of a block diagram of a machine 700 upon which any one or more of the techniques (e.g., methodologies) discussed herein may perform in accordance with some embodiments. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring May occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, alphanumeric input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 that is non-transitory on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

The following, non-limiting examples, detail certain aspects of the present subject matter to solve the challenges and provide the benefits discussed herein, among others.

Example 1 is a method for security debt management comprising: identifying a security risk assessment including at least one security defect of an application; determining, using a model, a security debt score for the application based on the security risk assessment; comparing the security debt score to a security debt threshold for the application; and determining, for a particular time period, a minimum remediation for the at least one security defect of the application to reduce the security debt score, the minimum remediation based on a minimum remediation due during the particular time period and the security debt score.

In Example 2, the subject matter of Example 1 includes, wherein the minimum remediation is determined based on the security debt score traversing the security debt threshold.

In Example 3, the subject matter of Examples 1-2 includes, wherein the minimum remediation is based on a default minimum remediation for the particular time period when the security debt score does not traverse the security debt threshold.

In Example 4, the subject matter of Examples 1-3 includes, wherein the security risk assessment includes metadata corresponding to the at least one security defect, the metadata including at least one of type, severity, or age of the at least one security defect.

In Example 5, the subject matter of Examples 1-4 includes, wherein the security risk assessment corresponds to a set of applications, and wherein the minimum remediation applies to at least one of the set of applications.

In Example 6, the subject matter of Examples 1-5 includes, wherein the security risk assessment corresponds to an enterprise, and wherein the minimum remediation applies to a common security defect among a plurality of applications of the enterprise.

In Example 7, the subject matter of Examples 1-6 includes, wherein the security risk assessment includes at least one compensating control for the application.

In Example 8, the subject matter of Examples 1-7 includes, wherein the security debt score is based on an amount, a type, a severity, or an age of an unmet security requirement of the application.

In Example 9, the subject matter of Examples 1-8 includes, wherein interest is accrued on the security debt score, and wherein the minimum remediation is increased for a subsequent time period based on the interest.

In Example 10, the subject matter of Examples 1-9 includes, wherein the minimum remediation is increased at an end of a subsequent time period when the minimum remediation is not addressed during the subsequent time period.

In Example 11, the subject matter of Examples 1-10 includes, displaying a carried debt balance, the minimum remediation, an interest accrued if the carried debt balance is not paid, and a penalty due if the minimum remediation is not addressed.

In Example 12, the subject matter of Examples 1-11 includes, determining, for a subsequent time period and, a future minimum remediation, before the subsequent time period, for the at least one security defect of the application to prevent a penalty based on the security debt score.

In Example 13, the subject matter of Examples 1-12 includes, identifying a largest cause of the security debt score including at least one of a programming language, a host, a deployment, or a framework of the application, and displaying the largest cause.

In Example 14, the subject matter of Examples 1-13 includes, wherein the minimum remediation is based on a total technical debt score, the total technical debt score including the security debt score and at least one other technical debt score based on a bug or a missing feature of the application.

Example 15 is at least one non-transitory machine-readable medium including instructions for security debt management, which when executed by processing circuitry, cause the processing circuitry to: identify a security risk assessment including at least one security defect of an application; determine, using a model, a security debt score for the application based on the security risk assessment; compare the security debt score to a security debt threshold for the application; and determine, for a particular time period, a minimum remediation for the at least one security defect of the application to reduce the security debt score, the minimum remediation based on a minimum remediation due during the particular time period and the security debt score.

In Example 16, the subject matter of Examples 1-15 includes, wherein the minimum remediation is determined based on whether the security debt score traverses the security debt threshold, and when the security debt score does not traverse the security debt threshold, applying a default minimum remediation for the particular time period.

In Example 17, the subject matter of Examples 1-16 includes, wherein the security risk assessment includes at least one compensating control for the application and metadata corresponding to the at least one security defect, the metadata including at least one of type, severity, or age of the at least one security defect.

In Example 18, the subject matter of Examples 1-17 includes, wherein the minimum remediation is based on a total technical debt score, the total technical debt score including the security debt score and at least one other technical debt score based on a bug or a missing feature of the application.

Example 19 is a system for security debt management comprising: processing circuitry; a display device; memory, including instructions, which when executed by the processing circuitry, cause the processing circuitry to perform operations to: identify a security risk assessment including at least one security defect of an application; determine, using a model, a security debt score for the application based on the security risk assessment; compare the security debt score to a security debt threshold for the application; determine, for a particular time period, a minimum remediation for the at least one security defect of the application to reduce the security debt score, the minimum remediation based on a minimum remediation due during the particular time period and the security debt score; and cause the display device to display a carried debt balance, the minimum remediation, an interest accrued if the carried debt balance is not paid, and a penalty due if the minimum remediation is not addressed.

In Example 20, the subject matter of Example 19 includes, wherein the instructions, when executed, further cause the processing circuitry to identify a largest cause of the security debt score including at least one of a programming language, a host, a deployment, or a framework of the application; and wherein the display device is further caused to display the largest cause.

Example 21 is a method for security debt management comprising: identifying a security risk assessment including at least one security defect of an application related to a user; determining, using a model, a security credit score for the user based on the security risk assessment; comparing the security credit score to a security credit threshold for the user; and determining, for a particular time period, a minimum remediation for the at least one security defect of the application to improve the security credit score, the minimum remediation based on a minimum remediation due during the particular time period and the security credit score.

In Example 22, the subject matter of Example 21 includes, wherein the minimum remediation is determined based on the security credit score traversing the security credit threshold.

In Example 23, the subject matter of Examples 21-22 includes, wherein the security credit score for the user is based on a set of applications and corresponding security debts for the set of applications.

In Example 24, the subject matter of Examples 21-23 includes, wherein the security risk assessment includes metadata corresponding to the at least one security defect, the metadata including at least one of type, severity, or age of the at least one security defect.

In Example 25, the subject matter of Examples 21-24 includes, wherein the security risk assessment includes at least one compensating control for the application.

In Example 26, the subject matter of Examples 21-25 includes, wherein the security credit score is based on an amount, a type, a severity, or an age of an unmet security requirement of the application.

In Example 27, the subject matter of Examples 21-26 includes, wherein the minimum remediation is increased at an end of a subsequent time period when the minimum remediation is not addressed during the subsequent time period.

In Example 28, the subject matter of Examples 21-27 includes, determining, for a subsequent time period, a future minimum remediation, before the subsequent time period, for the at least one security defect of the application to prevent a penalty based on the security credit score.

Example 29 is at least one machine-readable medium including instructions that, when executed by processing circuitry, cause the processing circuitry to perform operations to implement of any of Examples 1-28.

Example 30 is an apparatus comprising means to implement of any of Examples 1-28.

Example 31 is a system to implement of any of Examples 1-28.

Example 32 is a method to implement of any of Examples 1-28.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for security debt management comprising:
identifying a security risk assessment including at least one security defect of an application;
determining, using a model, a security debt score for the application based on the security risk assessment;
comparing the security debt score to a security debt threshold for the application; and
determining, for a particular time period, a minimum remediation for the at least one security defect of the application to reduce the security debt score, the minimum remediation based on a minimum remediation due during the particular time period and the security debt score.

2. The method of claim 1, wherein the minimum remediation is determined based on the security debt score traversing the security debt threshold.

3. The method of claim 1, wherein the minimum remediation is based on a default minimum remediation for the particular time period when the security debt score does not traverse the security debt threshold.

4. The method of claim 1, wherein the security risk assessment includes metadata corresponding to the at least one security defect, the metadata including at least one of type, severity, or age of the at least one security defect.

5. The method of claim 1, wherein the security risk assessment corresponds to a set of applications, and wherein the minimum remediation applies to at least one of the set of applications.

6. The method of claim 1, wherein the security risk assessment corresponds to an enterprise, and wherein the minimum remediation applies to a common security defect among a plurality of applications of the enterprise.

7. The method of claim 1, wherein the security risk assessment includes at least one compensating control for the application.

8. The method of claim 1, wherein the security debt score is based on an amount, a type, a severity, or an age of an unmet security requirement of the application.

9. The method of claim 1, wherein interest is accrued on the security debt score, and wherein the minimum remediation is increased for a subsequent time period based on the interest.

10. The method of claim 1, wherein the minimum remediation is increased at an end of a subsequent time period when the minimum remediation is not addressed during the subsequent time period.

11. The method of claim 1, further comprising displaying a carried debt balance, the minimum remediation, an interest accrued if the carried debt balance is not paid, and a penalty due if the minimum remediation is not addressed.

12. The method of claim 1, further comprising determining, for a subsequent time period, a future minimum remediation, before the subsequent time period, for the at least one security defect of the application to prevent a penalty based on the security debt score.

13. The method of claim 1, further comprising identifying a largest cause of the security debt score including at least one of a programming language, a host, a deployment, or a framework of the application, and displaying the largest cause.

14. The method of claim 1, wherein the minimum remediation is based on a total technical debt score, the total technical debt score including the security debt score and at least one other technical debt score based on a bug or a missing feature of the application.

15. At least one non-transitory machine-readable medium including instructions for security debt management, which when executed by processing circuitry, cause the processing circuitry to:
identify a security risk assessment including at least one security defect of an application;
determine, using a model, a security debt score for the application based on the security risk assessment;
compare the security debt score to a security debt threshold for the application; and
determine, for a particular time period, a minimum remediation for the at least one security defect of the application to reduce the security debt score, the minimum remediation based on a minimum remediation due during the particular time period and the security debt score.

16. The at least one machine-readable medium of claim 15, wherein the minimum remediation is determined based on whether the security debt score traverses the security debt threshold, and when the security debt score does not traverse the security debt threshold, applying a default minimum remediation for the particular time period.

17. The at least one machine-readable medium of claim 15, wherein the security risk assessment includes at least one compensating control for the application and metadata corresponding to the at least one security defect, the metadata including at least one of type, severity, or age of the at least one security defect.

18. The at least one machine-readable medium of claim 15, wherein the minimum remediation is based on a total technical debt score, the total technical debt score including the security debt score and at least one other technical debt score based on a bug or a missing feature of the application.

19. A system for security debt management comprising:
processing circuitry;
a display device;
memory, including instructions, which when executed by the processing circuitry, cause the processing circuitry to perform operations to:
identify a security risk assessment including at least one security defect of an application;
determine, using a model, a security debt score for the application based on the security risk assessment;
compare the security debt score to a security debt threshold for the application;
determine, for a particular time period, a minimum remediation for the at least one security defect of the application to reduce the security debt score, the minimum remediation based on a minimum remediation due during the particular time period and the security debt score; and
cause the display device to display a carried debt balance, the minimum remediation, an interest accrued if the carried debt balance is not paid, and a penalty due if the minimum remediation is not addressed.

20. The system of claim 19, wherein the instructions, when executed, further cause the processing circuitry to identify a largest cause of the security debt score including at least one of a programming language, a host, a deployment, or a framework of the application; and wherein the display device is further caused to display the largest cause.
